(19) United States
(12) Patent Application Publication
(10) Pub. No.: US 2022/0363011 A1
(43) Pub. Date: Nov. 17, 2022

(54) PROTECTION OF 3D OBJECTS

(71) Applicant: Hewlett-Packard Development Company, L.P., Spring, TX (US)

(72) Inventors: Pol Fornos Martinez, Sant Cugat del Valles (ES); Manuel Freire Garcia, Sant Cugat del Valles (ES); Ismael Fernandez Aymerich, Sant Cugat del Valles (ES)

(73) Assignee: Hewlett-Packard Development Company, L.P., Spring, TX (US)

(21) Appl. No.: 17/761,233

(22) PCT Filed: Oct. 9, 2019
(86) PCT No.: PCT/US2019/055378

§ 371 Date: Mar. 17, 2022

(51) Int. Cl. B29C 64/393; B29C 64/40; B33Y 50/02

(52) U.S. Cl. CPC B29C 64/393; B29C 64/40; B33Y 50/02; B29C 64/153

(57) ABSTRACT

Printer control data is generated which includes a three dimensional model for a protective structure to be built around a printed object by a three-dimensional printing apparatus, which protective structure is configured to compensate for the distorting effects of uneven shrinkage during cooling. The three dimensional model for the protective structure comprises a plurality of side panels and at least one extensible member interconnecting two or more of the side panels, which extensible member is configured to be extensible in response to shrinkage of the plurality of side panels during cooling. A method and apparatus is disclosed which obtains object model data defining an object to be built by a three-dimensional printing apparatus and automatically generates a three dimensional model for a suitable protective structure that has extensibility as an integral feature of the design to compensate for uneven shrinkage.

### BACKGROUND

Following completion of a build operation in a three-dimensional (3D) printing apparatus that uses raised temperatures during printing, built objects may be removed from the printing apparatus for cooling. This enables the printing apparatus to be used for other printing jobs while objects are cooling. Some 3D printing systems include a build unit that is a removable component of a printing system. A build process is followed by removal of the build unit to a place where it can be cooled. Printed objects may be cooled in the build unit or removed from the build unit to complete their cooling. To avoid movement of the build unit or removal of objects from the build unit damaging the built objects while they are in a structurally vulnerable state (i.e. when not yet fully cooled), a protective cage or “transfer box” may be built around a printed object or set of objects as part of the 3D printing process. The protective structure protects built objects during cooling.

### BRIEF DESCRIPTION OF THE DRAWINGS

Apparatus, methods and computer program products are described below, by way of example, with reference to the accompanying drawings in which:

FIG. 1a is an example of a 3D printed protective structure.

FIG. 1b is a magnified view of the example in FIG. 1a.

FIG. 1c is a magnified view of the example in FIG. 1b.

FIG. 2 is an example of a deformable element for use as part of a printed protective structure.

FIG. 3 is an example of a method for modifying a protective structure design.

FIG. 4 is an example of a calibration print.

FIG. 5 is an example of a method for generating printer control data.

FIG. 6 is an example of a computer readable medium comprising instructions to generate printer control data.

FIG. 7 is an example of a system for generating printer control instructions.

### DETAILED DESCRIPTION

In some 3D printers, an object or a plurality of separate objects may be built by selectively heating, melting, and coalescing/fusing powder particles in a build chamber of a build unit that is connected to a printing unit which controls the build operation. After the completion of the build operation, the build unit containing the object may be disconnected from the printing unit for initial cooling, which may involve connecting the disconnected build unit to a cooling system. Alternatively, a build unit can be left to cool naturally. To allow the build unit to be available for other build operations, it may be desirable for the built objects to be removed from the build chamber before cooling is complete. In systems using thermal fusing of build material, the built objects may be vulnerable to distortions until they have been cooled below a safe temperature, so there may be a delay before built objects are cold enough to be safely extracted from the build chamber, and there may be a consequent delay before a build unit is connected back to the printing unit to start a new printing process. The cooling of the contents of the build chamber (a printed object or objects and unfused build material) may take a considerable amount of time.

To enable extraction of built objects from the build chamber before cooling is completed following the printing process, a protective structure may be printed around the build objects during the printing of the build objects. The protective structure (which may be referred to as a ‘transfer box’, envelope or cage) protects the built objects until they have cooled sufficiently, in particular avoiding damage during the early extraction when the built objects are in a structurally vulnerable state.

Following a printing operation using a build material that exhibits thermal expansion, printed parts undergo shrinkage as melted and partially melted build material starts to cool. To compensate for shrinkage, objects may be printed to a specification which increases the dimensions of the printed objects in anticipation of shrinkage during cooling. However, this type of compensation relies on there being sufficient space in the build chamber to print these “scaled-up” parts, which will then shrink back to a desired size when cooled. The amount and speed of shrinkage of different portions of the printed parts can vary with the density of fused build material and temperature gradients and factors such as the location of the printed part in the build chamber, the geometry of the printed part, and cooling mechanisms may affect the rate of cooling of the printed parts to cause further variations. This variance in shrinkage can lead to distortions in the printed parts, potentially causing defects and reducing the dimensional accuracy of the printed parts. A partial solution to these issues is to carefully control the rate of cooling of the printed parts so as to reduce the variance in rates of shrinkage and thereby reduce distortion, but this may slow cooling and therefore delay the start of the next build.

Similarly to the printed products and parts, the protective structure is also a printed part and also undergoes shrinkage during cooling. In some situations, shrinkage and distortion of the protective structure during cooling can cause it to come into contact with printed parts that are inside the protective structure, and this can directly affect the dimensional accuracy of the contained printed parts. This issue may be compounded by the limited space around the periphery of a build chamber in which a protective structure or ‘transfer box’ is built (i.e. in some cases, it may be impossible to build a larger transfer box). Furthermore, the potential for warping during shrinkage may be increased if efforts are made to minimize the wall thickness of a transfer box for the sake of minimizing the amount of material used to build the transfer box. It is desirable to mitigate this risk of a protective structure itself causing distortions of printed parts.

The examples described below address this issue by use of protective structure designs that include components that are specifically designed to deform more easily than the rest of the protective structure. An example protective structure or ‘transfer box’ design includes one or more extensible members—i.e. members that are configured to deform under tension in a way that allows increased separation between the ends of an extensible member. By designing deformability or extensibility into certain components, the remaining components of a transfer box are allowed to shrink with less distortion of the components and of the overall protective structure.

In an example 3D printing apparatus that is capable of building protective structures around printed product parts, the 3D printer's printing control unit includes instructions to generate a three dimensional model for a protective structure that includes one or more extensible members interconnecting panels of the protective structure. The interconnected panels (referred to below as “side panels”) can be planar components forming the side walls and top and potentially the bottom of a protective structure. The extensible members are configured to deform more easily than the rest of the protective structure, including to extend in response to shrinkage of the side panels, and this allows controlled shrinkage of the side panels with less distortion of the side panels or the overall protective structure than would otherwise be the case. The instructions may be implemented in computer program code. The protective structure may then be built by a 3D printer simultaneously with other printed parts.

The present disclosure describes how generation of printer control data may be improved to reduce distortion of the protective structure that could otherwise occur during shrinkage following printing operations.

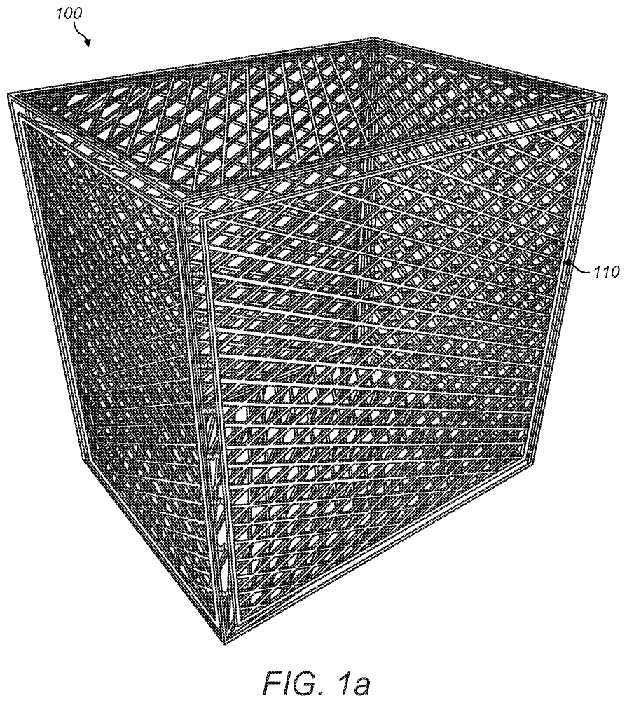

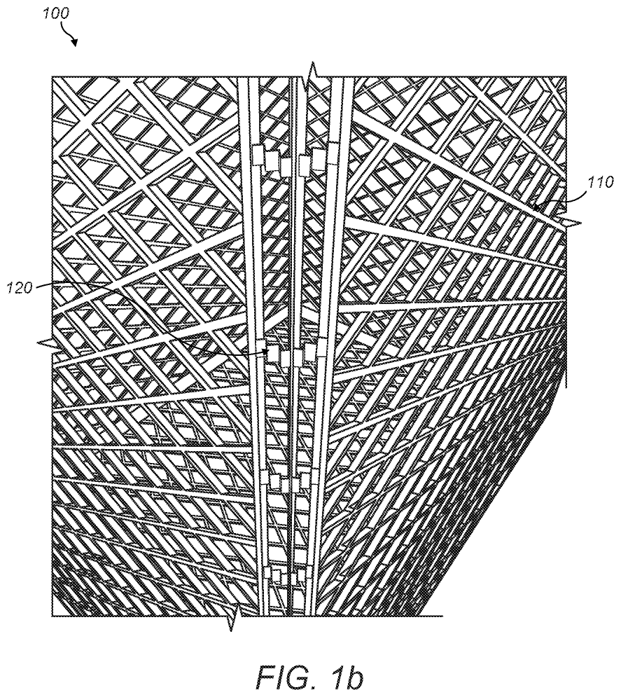

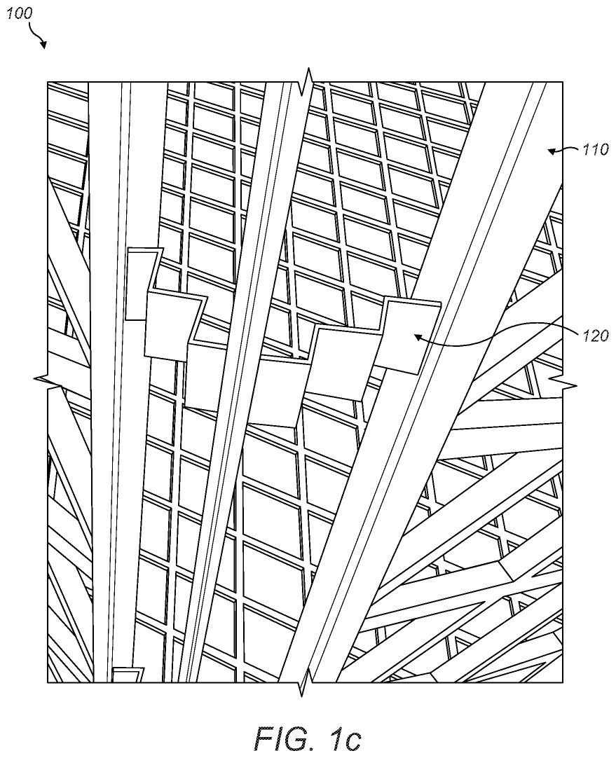

FIGS. 1a-c show an example of a 3D protective structure 100 comprising side panels 110 interconnected by a plurality of extensible members 120, which protective structure is intended to contain one or more printed products (not shown). The example protective structure 100 shown in the figures comprises a cage for enclosing a printed product in which the side panels have an open mesh structure. Although the individual threads forming the mesh of each side panel can be relatively thin linear components, a large number of interconnections between the threads of each side panel provide structural support to each other and therefore a degree of structural integrity of each side panel, which helps to maintain the shape of the side panel during shrinkage. In contrast from the side panels, the extensible members are designed to be supported at their ends, and to be extensible between those end points, allowing easier deformation of the extensible members than the side panels during shrinkage of the protective structure. The extensible members are unusual in that they are designed to extend by deformation, while the material that they are made of is shrinking, under tension that is applied by the shrinking of the side panels. In this way, a set of relatively small and easily deformable components of the protective structure provide the protective structure with increased flexibility to cope with shrinkage and especially a greater capacity to retain the overall shape of the protective structure by avoiding distortion of the side panels. The improved structural integrity provided by the extensible members may reduce the amount of build powder that is needed to build the protective structure.

In other examples, the protective structure is a hollow structure comprising solid side panels or side panels with a different mesh structure, and the extensible members can have many different shapes that provide easier deformation than the side panels that they interconnect. The protective structure 100 may have any geometry as long as it is large enough to contain a printed product. The protective structure 100 in the example shown in FIGS. 1a to 1c comprises a plurality of walls 110 connected together via a plurality of extensible members 120 that are designed to be deformed more easily than other components of the protective structure. In particular, the extensible members are configured to extend via deformation when put under tension during cooling, although they may deform in more than one direction simultaneously. Although the example shown in the figures includes nine extensible members attached to each of the four edges of each of six side panels, any number of extensible members may be provided. In some examples, a single extensible member 120 forms an integral part of the protective structure 110. In some examples, the one or more extensible members 120 form an integral part of the walls themselves, resulting in the plurality of walls each having deformable portions. In the example of FIGS. 1a to 1c, an outer frame defines the extremities of the protective structure and the edges of this outer frame are each connected to two adjacent side panels by a plurality of extensible elements. This configuration constrains the direction of deformation of the extensible elements, but the outer frame is not an essential component of the protective structure.

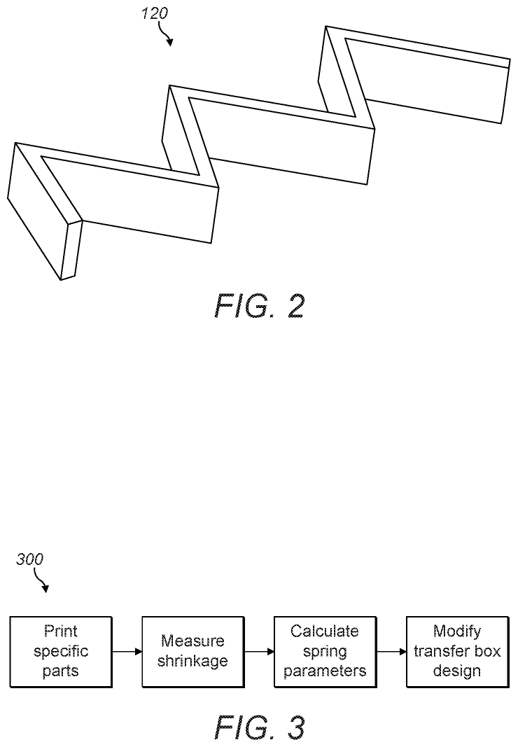

FIG. 1c and FIG. 2 show two examples of extensible members 120 that are configured to extend under tension, and which are suitable for use in a protective structure 100 such as shown in FIG. 1a. In the illustrated example of FIG. 2, the extensible member 120 is configured with multiple folds along its length, which can unfold under tension. In other examples, the extensible member has an alternative non-linear configuration (e.g. a helix shape instead of the saw-tooth shape of FIG. 2) or a telescoped configuration or other shape that includes folds or a bent/curved portion than can extend in at least one direction under tension. In some examples, the extensible member 120 is configured to deform more easily in one direction than in other directions. In some examples, the extensible member 120 is arranged to deform more easily than the walls of the protective structure 100. Extensible members configured with a series of folds, such as the uniform series of folds shown in FIGS. 1c and 2, remain within a small bounding space and avoid contact with printed objects within the protective structure, when they are deformed by shrinkage of the protective structure.

FIG. 3 shows an example method 300 for determining the desired extensibility of the extensible members of a protective structure, by measuring variations in the extent and speed of shrinkage at different locations within a printable volume. The method involves measuring shrinkage of a printed part to determine an expected shrinkage of the side panels of a protective structure before it is built. This determined shrinkage is then used to determine desired parameters including a desired extensibility of the extensible members. This can be implemented as a specification of suitable fold lengths and/or angles between the folds of each extensible member, to provide sufficient extensibility. The method 300 comprises: printing specific calibration parts; measuring the shrinkage of the printed calibration parts to determine an expected shrinkage of the side panels of the protective structure including variations in expected shrinkage for different parts of the structure; calculating a desired extensibility of the extensible elements to compensate for shrinkage of the side panels of the protective structure; and generating a three dimensional model for the protective structure that includes the extensible members. This generated model includes extensible members having the desired deformability to compensate for shrinkage and thereby maintain the integrity of the protective structure.

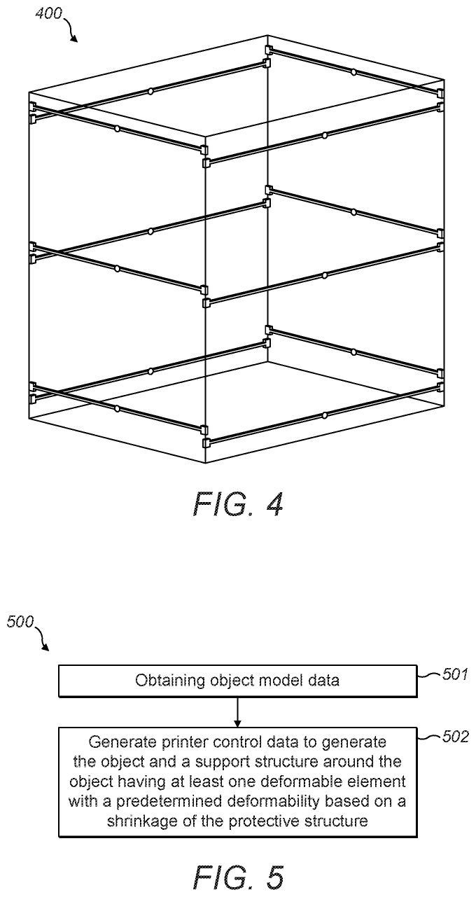

FIG. 4 shows an example of a plurality of printed calibration parts for determining the shrinkage at different locations within a print volume. In the present example, the calibration print comprises the printing of components at multiple locations in the build volume of a three-dimensional printer. In an example, the multiple locations may correspond to the locations of the printable volume where a protective structure is to be printed, which may be around the periphery of the printable volume. The calibration print may be printed using a build unit of the three-dimensional printer, and extracted from the build unit for cooling. During cooling and once the calibration print has cooled, it is possible to measure variations between measured and specified dimensions and between different parts and at various times. The measured variations are indicative of the speed and degree of shrinkage experienced at each of the multiple locations of the printable volume. Any variation between the degree/rate of shrinkage at each of the multiple locations of the build volume is indicative of a risk of distortions in the shape of a protective structure—which can be compensated for by use of extensible members. The greater the variations in shrinkage, the greater the risk of distortion in the shape of a protective structure. The determined shrinkage may be used to calculate a desired extensibility and any other desired deformability of the protective structure to compensate for the determined variations in shrinkage, and this can be used to modify the design of the protective structure through the addition of deformable elements having an appropriate deformability at specific locations in the protective structure, resulting in the protective structure that deforms more predictably.

FIG. 5 shows an example of a method 500 for generating printer control data for reducing the risk of distortion in a printed structure. In the illustrated example, the method 500 comprises obtaining 501 object model data defining an object to be built and generating 502 instructions to generate build data comprising the obtained object model and a protective structure model which defines a protective structure to be built around the object. The printer control data further comprises instructions to cause a three-dimensional printing apparatus to build at least one extensible member or relatively highly-deformable element as an integral part of the protective structure, wherein the instructions cause at least one deformable element to be built with a predetermined extensibility and deformability based on an expected shrinkage and deformation of the protective structure during cooling.

In some examples, the printer control data instructions cause the three-dimensional printing apparatus to build a plurality of deformable and extensible elements as an integral part of the protective structure, wherein each of the plurality of deformable and extensible elements are built at locations in the protective structure based on locations where the expected distortion of the protective structure is greatest. Warping/distortion of the protective structure occurs when there is disproportionate shrinkage across the protective structure. Strategic positioning of the plurality of deformable elements compensates for disproportionate shrinkage to reduce distortion in the shape of the protective structure.

In some examples, the printer control data instructions cause the three-dimensional printing apparatus to build a plurality of deformable elements as an integral part of the protective structure, wherein each of the plurality of deformable elements are built having a deformability based on a distortion of the protective structure at the location of the respective deformable element. In an example, the selected deformability properties for each of the plurality of deformable elements are based on the expected degree of shrinkage in the vicinity of the respective deformable element in relation to the degree of shrinkage at other portions of the protective structure. Tuning the selected properties for each of the plurality of deformable elements based on their position provides compensation for disproportionate shrinkage, reducing distortion in the shape of the protective structure.

In some examples, the printer control data instructions cause the three-dimensional printing apparatus to build the at least one deformable element having dimensions based on the predetermined deformability. As described above, the selected size, shape and/or structural properties for the at least one deformable element may vary significantly, and will be dependent on the obtained distortion data. In some examples, the dimensions of the deformable element may be selected from a database based on desired deformability properties. In some examples, the desired deformability properties may be selected from a database based on measured distortions. In some examples, the printer control data instructions cause the obtained distortion of the protective structure to be determined and/or estimated based on historical printing events and/or data. In some examples, the distortion is estimated based on the protective structure geometry, the protective structure material and knowledge of locations of the build volume that typically undergo disproportionate shrinkages during cooling.

In some examples, the printer control data instructions cause the three-dimensional printing apparatus to build the protective structure having a plurality of sections, wherein the at least one deformable element is built in a location of the protective structure connecting at least two sections of the plurality of sections. In one example, the printer control data instructions also cause the three-dimensional printing apparatus to build a plurality of deformable and extensible elements as an integral part of the protective structure, wherein each of the plurality of deformable elements are built at locations of the protective structure connecting adjacent sections of the plurality of sections of the protective structure.

In some examples, the method further comprises executing the generated printer control data on a three-dimensional printing apparatus to build the object and the protective structure.

FIG. 6 shows an example of controller 600 configured to generate printer control data. The controller 600 comprises a processor 601 and a memory 602. Stored within the memory 602 are instructions 605 for generating printer control data according to any one of the example methods disclosed above. In an example, controller 600 may be part of a computer running the instructions 605. In another example, controller 600 may be part of a powder-based 3D printer configured to run the instructions 605 after obtaining object model data.

In some examples, the at least one deformable element is adapted to deform more easily than other portions of the protective structure. The at least one deformable element may be selected to have deformability properties which cause the deformable element to deform in response to a disproportionate shrinkage of part of the protective structure, thereby preventing/reducing distortion of the protective structure.

In some examples, the printer control data instructions cause the additive manufacturing system to generate the protective structure having a plurality of sections or side panels, wherein the at least one extensible member is generated at a location on the protective structure connecting at least two sections of the plurality of sections. Optionally, the printer control data instructions may cause the additive manufacturing system to generate a plurality of extensible members as an integral part of the protective structure, wherein each of the plurality of extensible members are generated at a location on the protective structure connecting adjacent sections or side panels of the plurality of sections of the protective structure. Optionally, the plurality of deformable elements may be configured to deform to alter a distance between adjacent sections of the plurality of sections of the protective structure in response to a disproportionate shrinkage of a portion of the protective structure.

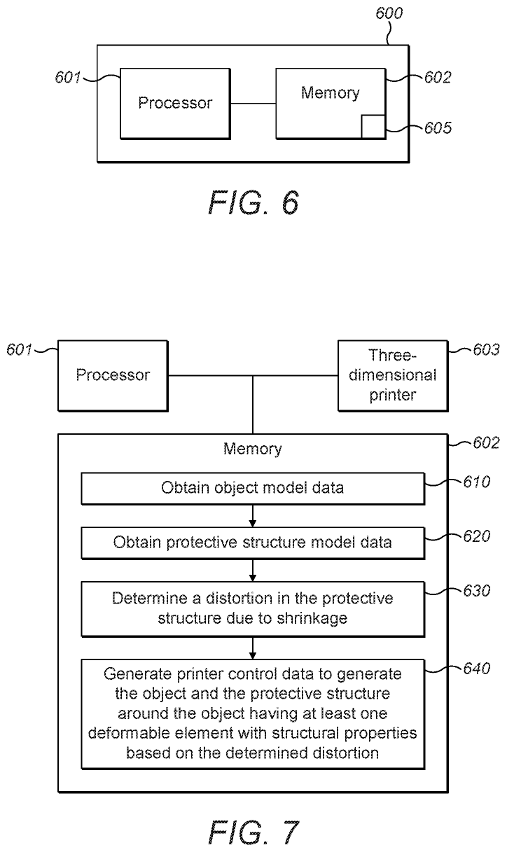

FIG. 7 shows a memory 602 which is an example of a computer-readable medium storing instructions that, when executed by a processor 601 communicably coupled to an additive manufacturing system 603, causes the processor 601 to generate printer control data. The computer-readable medium may be any electronic magnetic, optical or other physical storage device that stores executable instructions. Thus, the non-transient computer readable medium may be, for example, Random Access Memory (RAM), and Electrically-erasable Programmable read-Only Memory (EEPROM), a storage drive, an optical disc, and the like. A method for generating control data may include; obtaining 610 object model data; obtaining 620 model data for a protective structure to be built around the object; determining 630 a distortion in the protective structure due to shrinkage; and generating 640 printer control data to generate the object and the protective structure around the object having at least one deformable element with structural properties based on the determined distortion. In an example method, a protective structure model can be generated with extensible members formed as integral components, without measuring actual shrinkage.

1. A method comprising:
obtaining object model data defining an object to be built by a three-dimensional printing apparatus; and
automatically generating a three dimensional model for a protective structure to be built around the object by the three-dimensional printing apparatus, wherein the three dimensional model for the protective structure comprises a plurality of panels and at least one extensible member interconnecting two or more of the panels, which extensible member is configured to be extensible in response to shrinkage of the plurality of panels during cooling.

2. The method of claim 1, further comprising: generating printer control data comprising instructions to control a three-dimensional printing apparatus to build the object and to build the protective structure around the object.

3. The method of claim 2, wherein the printer control data comprises instructions to control the three-dimensional printing apparatus to build a plurality of extensible members at a plurality of locations between panels of the protective structure.

4. The method of claim 3 wherein the plurality of extensible members are each independently extensible, thereby to enable variable extension distances between the side panels in response to non-uniform shrinkage of the side panels during cooling.

5. The method of claim 1, wherein each extensible member is configured to be extensible by a distance that is predetermined to compensate for a predicted non-uniform shrinkage of the side panels of the protective structure.

6. The method of claim 3, wherein the printer control data instructions comprises instructions to control the three-dimensional printing apparatus to build a plurality of extensible members that are each configured to allow extension by a predetermined amount based on a predicted deformation of the protective structure at the location of the respective extensible member.

7. The method of claim 6, wherein the predicted deformation is determined from measured shrinkage of one or more printed objects.

8. The method of claim 3, wherein the printer control data instructions cause the three-dimensional printing apparatus to build the protective structure as a plurality of substantially flat side panels interconnected by a plurality of extensible elements that each interconnect at least two of the substantially flat side panels.

9. The method of claim 2, comprising executing the generated printer control data on a three-dimensional printing apparatus to control the apparatus to build the object and the protective structure.

10. A system comprising:
a controller configured to:
obtain object model data defining an object to be generated by an additive manufacturing system;
generate a three dimensional model for a protective structure to be built around the object by the additive manufacturing system, wherein the three dimensional model for the protective structure includes a plurality of panels and at least one extensible member forming an integral part of the protective structure and interconnecting two or more of the panels, which extensible member is configured to be extensible in response to deformation of the protective structure.

11. A system according to claim 10, wherein the controller is configured to generate control data for controlling the additive manufacturing system to build the object and the protective structure.

12. A system according to claim 11, wherein the controller is configured to:
determine a predicted deformation of the protective structure during a cooling process, which follows an additive manufacturing operation; and
generate control data for controlling the additive manufacturing system to build at least one extensible member as an integral part of the protective structure, which extensible member is configured to be extensible by a predetermined distance to compensate for the predicted deformation of the protective structure.

13. A system according to claim 11, including an additive manufacturing system, wherein the controller is configured to control the additive manufacturing system to build the object and the protective structure.

14. The system of claim 10, wherein a predicted deformation of the protective structure due to cooling of the protective structure is determined based on one or more of: the protective structure geometry; the protective structure material; and/or information relating to shrinkage during cooling at locations in a three-dimensional printing apparatus build volume.

15. A computer-readable medium comprising instructions that; when executed by a processor communicably coupled to an additive manufacturing system, causes the processor to:
obtain object model data defining an object to be generated by the additive manufacturing system;
determine the dimensions of a protective structure within which the object is to be generated, the protective structure having at least two sections;
determine an expected deformation of the at least two sections of the protective structure during cooling following an additive manufacturing operation; and
generating printer control data comprising build data to control the additive manufacturing system to generate the object and the protective structure, wherein the printer control data comprises instructions to cause the additive manufacturing system to generate at least one extensible element interconnecting the at least two sections of the protective structure, wherein the instructions cause the generation of the at least one extensible element having predetermined structural properties to enable deformation of the extensible element to compensate for the expected deformation of the at least two sections of the protective structure.
